(19) United States
(12) Patent Application Publication
(10) Pub. No.: US 2026/0338264 A1
(43) Pub. Date: Oct. 29, 2026

(54) NEEDLE ROLLER SCREW

(71) Applicants: TSINGHUA UNIVERSITY, Beijing (CN); Wanfuxin Intelligent Equipment Co., Ltd, Dongguan (CN)

(72) Inventors: Wenyuan ZHANG, Beijing (CN); Gangtie ZHENG, Beijing (CN); Dongmei HE, Dongguan (CN); Jie ZENG, Dongguan (CN)

(21) Appl. No.: 19/657,053

(22) Filed: Apr. 24, 2026

(30) Foreign Application Priority Data
Apr. 27, 2025 (CN) 202510539436.6

(51) Int. Cl. F16H 25/22

(52) U.S. Cl. CPC F16H 25/2266

(57) ABSTRACT

A needle roller screw includes a screw central rod, a screw sleeve, an outer housing, and needle rollers. A first helical groove is formed on the outer periphery of the screw central rod. The screw sleeve is sleeved on the outer periphery of the screw central rod, and the screw sleeve has a second helical groove on an inner wall thereof and a third helical groove on an outer wall thereof. The outer housing is sleeved on the screw sleeve, and a fourth helical groove is formed on an inner wall of the outer housing. The first helical groove and the second helical groove cooperate to form an inner helical raceway. The third helical groove and the fourth helical groove cooperate to form an outer helical raceway. Two ends of the inner helical raceway are respectively in communication with two ends of the outer helical raceway through return ports.

### CROSS-REFERENCE TO RELATED APPLICATION

The present application claims priority to Chinese patent application No. 202510539436.6, titled “NEEDLE ROLLER SCREW” and filed with China National Intellectual Property Administration on Apr. 27, 2025, the entire contents of which are incorporated herein by reference.

### FIELD

The present application relates to the technical field of linear actuators, and in particular to a needle roller screw.

### BACKGROUND

In fields such as planetary exploration, some research requires the use of humanoid robots to perform tasks and carry out corresponding exploration and operations in place of humans, and at the same time requires that the humanoid robots closely resemble the human body in appearance. Currently, most humanoid robots employ rotationally driven joint structures. However, the structural dimensions of the shoulder joints and hip joints of robots constructed with such joint structures are typically large, differing significantly from the actual human body appearance. The characteristics of human muscle-driven motion cannot be simulated.

To address this technical problem, in the related art, rotary joints are replaced with linear joints to simulate the traction effect of muscles to drive joint movement, enabling joint dimensions to closely resemble the human body appearance. Commonly used linear actuators include ball screws and planetary threaded roller screws. However, in ball screws, the balls and the threads are in point contact with each other, resulting in limited load-bearing capacity. In planetary threaded roller screws, the threaded rollers are in line contact with the screw shaft with a relatively large contact area, and therefore the load-bearing capacity is strong. However, both rolling and sliding relative motion exist simultaneously between the screw shaft and the rollers. This sliding generates relatively large friction forces, which cause a large portion of the motor driving energy to be converted into heat and lost, thereby resulting in low transmission efficiency of the structure.

### SUMMARY

One or more embodiments of the present application provides a needle roller screw that can maintain high transmission efficiency while having high load-bearing capacity.

The present application provides a needle roller screw. The needle roller screw includes a screw central rod, a screw sleeve, an outer housing, and needle rollers. A first helical groove is formed on the outer periphery of the screw central rod. The screw sleeve is sleeved on the outer periphery of the screw central rod. A second helical groove radially opposite to the first helical groove is formed on an inner wall of the screw sleeve. A third helical groove is formed on an outer wall of the screw sleeve. The outer housing is sleeved on the outer periphery of the screw sleeve. A fourth helical groove radially opposite to the third helical groove is formed on an inner wall of the outer housing. The first helical groove and the second helical groove cooperate to form an inner helical raceway. The third helical groove and the fourth helical groove cooperate to form an outer helical raceway. Return ports are formed on the screw sleeve, and two ends of the inner helical raceway are respectively in communication with two ends of the outer helical raceway through the return ports. A plurality of needle rollers are provided. The plurality of needle rollers are closely arranged in the outer helical raceway and the inner helical raceway. An axis of each of the plurality of the needle rollers is perpendicular to an extending direction of each of the outer helical raceway and the inner helical raceway. The plurality of needle rollers are configured to circularly roll within the outer helical raceway and the inner helical raceway when the outer housing is rotated relative to the screw central rod.

Additional aspects and advantages of the present application will be partially set forth in the description below, partially become apparent from the description below, or be learned through practice of the present application.

### BRIEF DESCRIPTION OF THE DRAWINGS

The above and/or additional aspects and advantages of the present application will become apparent and readily understood from the following description of embodiments taken in conjunction with the accompanying drawings, in which:

FIG. 1 is a schematic structural view of a needle roller screw according to some embodiments of the present application;

FIG. 2 is an axial cross-sectional view of a needle roller screw according to some embodiments of the present application;

FIG. 3 is a schematic structural view of a screw central rod according to some embodiments of the present application;

FIG. 4 is an axial cross-sectional view of a screw central rod according to some embodiments of the present application;

FIG. 5 is a schematic structural view of an outer housing according to some embodiments of the present application;

FIG. 6 is an axial cross-sectional view of an outer housing according to some embodiments of the present application;

FIG. 7 is a schematic structural view of a screw sleeve according to some embodiments of the present application;

FIG. 8 is an axial cross-sectional view of a screw sleeve according to some embodiments of the present application;

FIG. 9 is a schematic structural view of a guide member according to some embodiments of the present application;

FIG. 10 is a cross-sectional view of a guide member according to some embodiments of the present application;

FIG. 11 is a schematic structural view of a needle roller according to some embodiments of the present application;

FIG. 12 is a schematic view of the arrangement of needle rollers according to some embodiments of the present application.

### LIST OF REFERENCE SIGNS

1 screw central rod
11 fitting section
111 first helical groove
112 limiting groove
12 smooth shaft section
13 output section
2 outer housing
21 fourth helical groove
3 screw sleeve
31 second helical groove
32 third helical groove
33 return port
4 guide member
41 return passage
42 protrusion
5 needle roller.

### DETAILED DESCRIPTION OF THE EMBODIMENTS

Embodiments of the present application are described in detail below. Examples of the embodiments are illustrated in the accompanying drawings, wherein the same or similar reference numerals throughout denote the same or similar elements or elements having the same or similar functions. The embodiments described below with reference to the accompanying drawings are exemplary and are only used to explain the present application and should not be construed as limiting the present application.

According to the needle roller screw of the present application, since the needle rollers can circularly roll in the outer helical raceway and the inner helical raceway through the return ports, the rotary motion of the outer housing can be converted into linear motion of the screw. Since the transmission between the needle rollers and the helical raceways primarily relies on rolling friction, the needle roller screw of the present application has high transmission efficiency on the basis of having high load-bearing capacity. Compared with a point contact employed in ball screw transmission, line contact is provided in the present application, thereby improving the load-bearing capacity. Compared with planetary threaded roller screws, sliding friction is reduced, thereby improving mechanical transmission efficiency.

According to some embodiments of the present application, the needle roller screw further includes a guide member. The guide member extends through each of the return ports. A radially inner end of the guide member is cooperatively connected to the screw central rod, and a radially outer end of the guide member is cooperatively connected to the outer housing. The guide member has a return passage through which the inner helical raceway is in communication with the outer helical raceway.

According to some embodiments of the present application, a helical direction of the inner helical raceway is opposite to a helical direction of the outer helical raceway. Each of two ends of the inner helical raceway is connected to one guide member. The extending directions of two return passages are opposite to each other.

According to some embodiments of the present application, a limiting groove is formed on the screw central rod. The guide member is at least partially disposed in the limiting groove, to be adapted to be cooperatively connected to the screw central rod.

According to some embodiments of the present application, the guide member is connected to the limiting groove by an interference fit.

According to some embodiments of the present application, a protrusion is formed at the radially outer end of the guide member. The protrusion is in sliding engagement with the fourth helical groove, to be adapted to be cooperatively connected to the outer housing.

According to some embodiments of the present application, a plurality of inner helical raceways and a plurality of outer helical raceways are provided. The plurality of inner helical raceways are in one-to-one correspondence with the plurality of outer helical raceways. The plurality of inner helical raceways are arranged at intervals along an axial direction of the screw central rod. The plurality of outer helical raceways are arranged at intervals along the axial direction of the screw central rod.

According to some embodiments of the present application, a part of each of the plurality of needle rollers is constructed into a cylindrical shape, and each of axial end surfaces of the needle roller is constructed as an arcuate shape.

According to some embodiments of the present application, the screw central rod includes an fitting section, a smooth shaft section, and an output section. The first helical groove is formed on the fitting section. One end of the smooth shaft section is connected to the fitting section. The output section is connected to the other end of the smooth shaft section. The output section is adapted to be connected to an external structure for outputting linear motion. The fitting section is disposed within the outer housing and is configured to drive the smooth shaft section and the output section to move along the axial direction of the outer housing.

According to some embodiments of the present application, a connection portion is formed on the outer periphery of the outer housing. The connection portion is configured to be connected to a driving component.

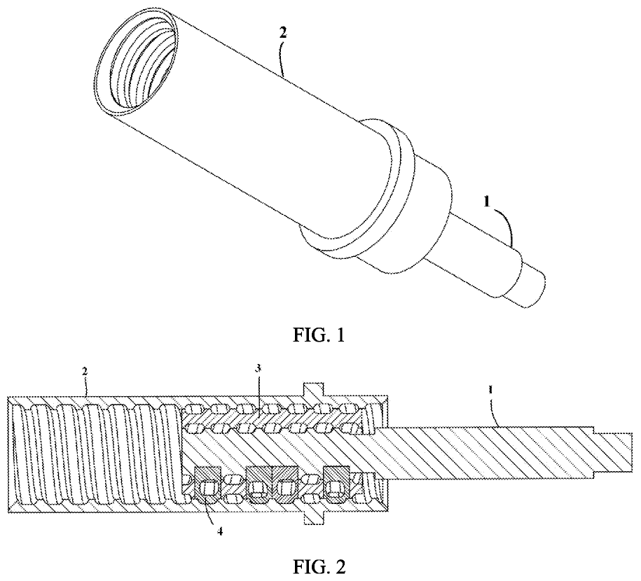

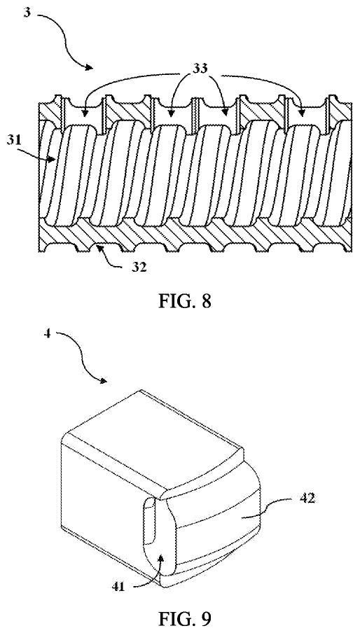

A needle roller screw according to embodiments of the present application is described below with reference to FIG. 1 to FIG. 12.

The present application provides a needle roller screw. The needle roller screw includes a screw central rod 1, a screw sleeve 3, an outer housing 2, and needle rollers 5. A first helical groove 111 is formed on the outer periphery of the screw central rod 1. The screw sleeve 3 is sleeved on the outer periphery of the screw central rod 1. A second helical groove 31 radially opposite to the first helical groove 111 is formed on an inner wall of the screw sleeve 3. A third helical groove 32 is formed on an outer wall of the screw sleeve 3. The outer housing 2 is sleeved on the outer periphery of the screw sleeve 3. A fourth helical groove 21 radially opposite to the third helical groove 32 is formed on an inner wall of the outer housing 2. The first helical groove 111 and the second helical groove 31 cooperate to form an inner helical raceway. The third helical groove 32 and the fourth helical groove 21 cooperate to form an outer helical raceway. Return ports 33 are formed on the screw sleeve 3, and both ends of the inner helical raceway are respectively in communication with both ends of the outer helical raceway through the return ports 33. A plurality of needle rollers 5 are provided. The plurality of needle rollers 5 are closely arranged in the outer helical raceway and the inner helical raceway. An axis of each of the plurality of needle rollers 5 is perpendicular to an extending direction of each of the outer helical raceway and the inner helical raceway. The needle rollers 5 are configured to circularly roll within the outer helical raceway and the inner helical raceway when the outer housing 2 is rotated relative to the screw central rod 1.

According to the needle roller screw of the present application, the screw sleeve 3 is sleeved on the outer periphery of the screw central rod 1, and the outer housing 2 is sleeved on the outer periphery of the screw sleeve 3. The screw sleeve 3 and the outer housing 2 are both in the form of hollow cylinders. The screw central rod 1, the screw sleeve 3, and the outer housing 2 are coaxially installed. The first helical groove 111 provided on the screw central rod 1 cooperates with the second helical groove 31 provided on the inner periphery of the screw sleeve 3 to form the inner helical raceway. The third helical groove 32 provided on the outer periphery of the screw sleeve 3 cooperates with the fourth helical groove 21 provided on the inner periphery of the outer housing 2 to form an outer helical raceway. The inner helical raceway is in communication with the outer helical raceway through return ports at both ends to form a complete closed raceway. The needle rollers 5 are closely arranged in the closed raceway, with their axes perpendicular to the extending direction of the closed raceway. Two adjacent needle rollers 5 are tangential to each other and can undergo relative rolling. In specific application of the needle roller screw of the present application, under the action of a driving force, the outer housing 2 and the screw 1 are configured to rotate relative to each other. The needle rollers 5 in the outer helical raceway roll within the outer helical raceway under the frictional action of the third helical groove 32 and the fourth helical groove 21, and drive all the needle rollers 5 to circularly roll within the entire closed raceway, pushing the screw central rod 1 to move axially relative to the outer housing 2, thereby converting rotary motion into linear motion.

The cross-sectional shape of each of the inner helical raceway and the outer helical raceway is the same as or similar to the axial cross-section of the needle roller 5. In this way, the position of the needle roller 5 is able to be limited such that the needle roller 5 rolls along the extending direction of the closed raceway.

In the present application, the needle roller 5 is in line contact with the third helical groove 32 and the fourth helical groove 21. Compared with point contact between balls and threads, the needle roller 5 having a larger contact area exhibits a higher load-bearing capacity. Compared with planetary roller screws, in the present application, the friction force caused by the line contact between the needle roller 5 and each of the third helical groove 32 and the fourth helical groove 21 is smaller, the driving loss is small, and the transmission efficiency is higher. Therefore, the needle roller screw of the present application has high transmission efficiency on the basis of having high load-bearing capacity.

Furthermore, since the inner helical raceway is disposed between the screw central rod 1 and the screw sleeve 3, and the outer helical raceway is disposed between the screw sleeve 3 and the outer housing 2, the closed raceway of the present application is entirely disposed within the structure of the needle roller screw, enabling the needle rollers 5 to circulate within the needle roller screw, thereby reducing the diameter of the outer housing. Therefore, the needle roller screw of the present application is more compact in structure, and has smaller outer dimension, making it suitable for limited installation spaces with a wider range of applications, thereby enabling its application in structural components such as joint components of humanoid robots.

In some embodiments, the inner helical raceway and the outer helical raceway have the same pitch.

According to some embodiments of the present application, the needle roller screw further includes a guide member 4. The guide member 4 extends through the return port 33. A radially inner end of the guide member 4 is cooperatively connected to the screw central rod 1, and a radially outer end of the guide member 4 is cooperatively connected to the outer housing 2. The guide member 4 has a return passage 41 through which the inner helical raceway is in communication with the outer helical raceway. In the present embodiment, by providing the guide member 4 having the return passage 41, on the basis of ensuring communication between the inner helical raceway and the outer helical raceway, the connection between the screw sleeve 3 and the screw central rod 1 as well as the mating connection between the screw sleeve 3 and the outer housing 2 can be achieved.

As shown in FIG. 2, the screw central rod 1, the screw sleeve 3, and the guide member 4 form an integral screw shaft structure. When the outer housing 2 is rotated relative to the screw central rod 1, due to the frictional action of the needle rollers 5 and the limiting action of the guide member 4 on the screw sleeve 3 and the screw central rod 1, the screw shaft structure moves linearly along the axial direction.

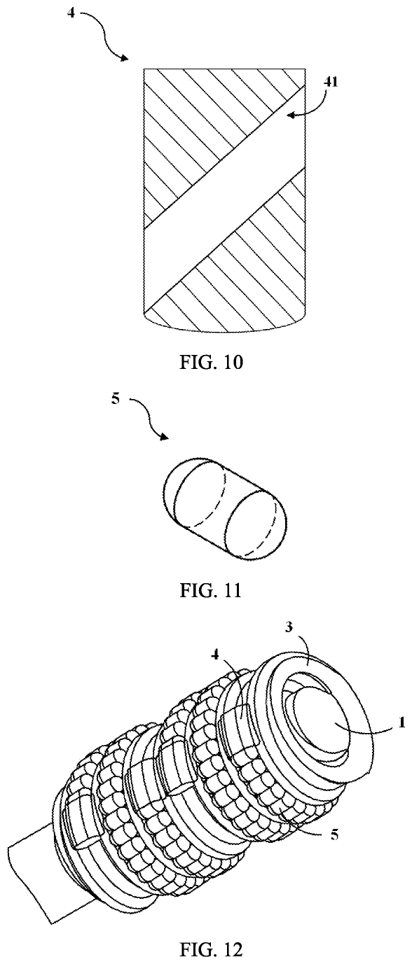

In some embodiments, as shown in FIG. 10, the return passage 41 is configured as a straight channel. The cross-sectional shape of the return passage is the same as or similar to the axial cross-sectional shape of the needle roller 5, to enable the needle roller 5 to roll stably within the straight channel.

According to some embodiments of the present application, a helical direction of the inner helical raceway is opposite to that of the outer helical raceway. Each of two ends of the inner helical raceway is connected to one guide member 4, and the extending directions of the two return passages 41 are opposite to each other. In the present embodiment, the opposite helical directions of the inner helical raceway and the outer helical raceway enable the needle rollers 5 to smoothly move through the return passage 41 when circularly rolling in the closed raceway. The opposite helical directions ensure the continuity and smoothness of the circulation path for the needle rollers 5, avoiding structural jamming and ensuring high transmission efficiency.

According to some embodiments of the present application, a limiting groove 112 is formed on the screw central rod 1. The guide member 4 is at least partially disposed in the limiting groove 112, so as to be adapted to be cooperatively connected to the screw central rod 1. The guide member 4 is connected to the limiting groove 112 by an interference fit. In at least one embodiment as shown in FIG. 2 to FIG. 4, the connection by an interference fit between the limiting groove 112 and the guide member 4 serves to fasten the screw central rod 1 and the screw sleeve 3, maintaining the relative fixation of the respective structures.

In some embodiments, the cross-section of the guide member 4 is constructed as a rectangular shape. The return port 33 is configured as a rectangular through-hole matching the guide member 4. The limiting groove 112 is configured as a rectangular groove matching the guide member 4.

According to some embodiments of the present application, a protrusion 42 is formed at the radially outer end of the guide member 4. The protrusion 42 is in sliding engagement with the fourth helical groove 21, so as to be adapted to be cooperatively connected to the outer housing 2. In at least one embodiment as shown in FIG. 2 and FIG. 9, the protrusion 42 is in sliding engagement with the fourth helical groove 21. When the outer housing 2 is rotated relative to the screw central rod 1, the needle rollers 5 roll in the closed raceway to drive the screw central rod 1 and the screw sleeve 3 to move axially, and the protrusion 42 slides relative to the fourth helical groove 21. The protrusion 42 provides a slidable limiting connection between the screw sleeve 3 and the outer housing 2.

According to some embodiments of the present application, a plurality of inner helical raceways and a plurality of outer helical raceways are provided. The plurality of inner helical raceways are in one-to-one correspondence with the plurality of outer helical raceways. The plurality of the inner helical raceways are arranged at intervals along the axial direction of the screw central rod 1. The plurality of outer helical raceways are arranged at intervals along the axial direction of the screw central rod 1. In at least one embodiment as shown in FIG. 12, a plurality of inner helical raceways and a plurality of outer helical raceways are provided, i.e., a plurality of closed raceways are provided. Each inner helical raceway is in communication with a corresponding outer helical raceway through a pair of guide members 4, and the extending directions of each pair of guide members 4 are opposite to each other. Each closed raceway is formed independently, and each closed raceway is provided with a closely arranged group of needle rollers 5, which circularly roll within the independent closed raceway. The present embodiment provides multiple closed raceways, which can reduce the friction between a single individual closed raceway and the needle rollers 5 while having sufficient load-bearing capacity. In this way, problems such as jamming due to excessively long raceways are avoided. In some embodiments, the multiple pairs of guide members 4 in the multiple closed raceways are arranged at intervals along the axial direction.

According to some embodiments of the present application, a part of the needle roller 5 is constructed into a cylindrical shape, and each of the axial end surfaces of the needle roller 5 is constructed as an arcuate shape. In the present embodiment, the cylindrical portion of the needle roller 5 is tangential to the closed raceway and is adapted for relative rolling. Since the closed raceway is a complete closed path and the extending direction of the closed raceway is not everywhere the same. In at least one embodiment as shown in FIG. 11, the axial end surfaces of the needle roller 5 are constructed as arcuate surfaces, which can avoid problems such as jamming and blockage between the needle roller 5 and the closed raceway during rolling, and at the same time can reduce sliding friction caused by contact between the axial ends of the needle roller 5 and the closed raceway, ensuring smooth rolling of the needle roller 5 within the closed raceway. In some embodiments, the middle portion of the needle roller 5 is configured to be cylindrical, and the two end portions are configured to be hemispherical. The needle rollers 5 are tangential to each other along the cylindrical side surfaces and can undergo relative rolling. Furthermore, the surface of the needle roller 5 is configured as a smooth surface to reduce friction.

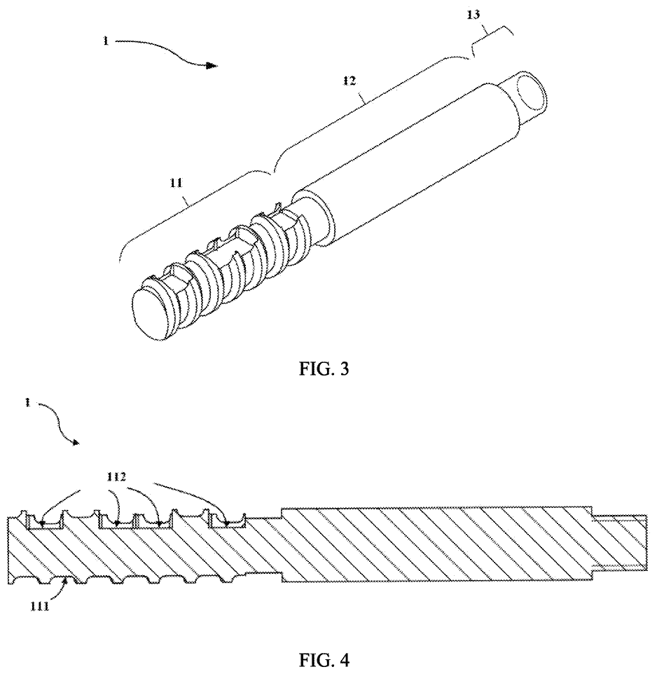

According to some embodiments of the present application, the screw central rod 1 includes an fitting section 11, a smooth shaft section 12, and an output section 13. The first helical groove 111 is formed on the fitting section 11. One end of the smooth shaft section 12 is connected to the fitting section 11. The output section 13 is connected to the other end of the smooth shaft section 12. The output section 13 is adapted to be connected to an external structure for outputting linear motion. The fitting section 11 is disposed within the outer housing 2 and is adapted to drive the smooth shaft section 12 and the output section 13 to move along the axial direction of the outer housing 2. In at least one embodiment as shown in FIG. 3 and FIG. 4, the fitting section 11 is configured to be in transmission connection with the screw sleeve 3 and the outer housing 2. The output section 13 serves as the output end of linear motion, and is connected to external structures such as moving components through threads and rod-end bearings and the like. The smooth shaft section 12 is configured to connect the fitting section 11 to the output section 13. The outer periphery of the smooth shaft section 12 is configured as a smooth surface. The smooth shaft section 12 can be driven by the fitting section 11 to partially extend into the outer housing 2 and partially extend out of the outer housing 2, so as to be adapted to connect with other components through the output section 13. The smooth shaft section 12 not only provides a connecting function but also ensures the movement space for the fitting section 11 within the outer housing 2, thereby avoiding structural interference. The length of the fitting section 11 can be designed according to actual load-bearing requirements and friction conditions.

In some embodiments, as shown in FIG. 6, within the axial length range of the outer housing 2, the inner wall of the outer housing 2 is entirely provided with the fourth helical groove 21, to enable the screw to be at all times cooperatively connected to the outer housing 2 through the third helical groove 32, the fourth helical groove 21, and the needle rollers 5 during movement, achieving continuous motion transmission. When the needle roller screw is in operation, the axial movement range of the screw sleeve 3 does not exceed the axial length range of the outer housing 2, and the working stroke of the needle roller screw is equal to the length of the outer housing 2 minus the length of the screw sleeve 3.

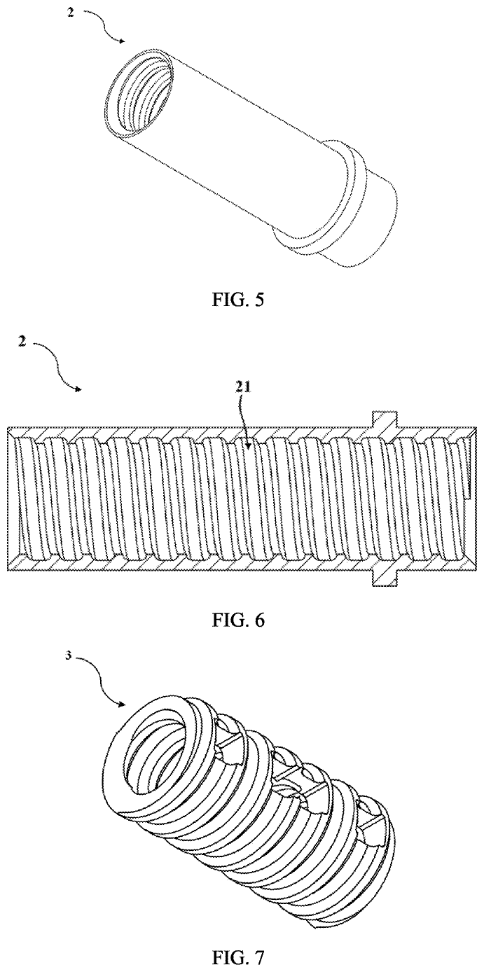

According to some embodiments of the present application, a connection portion is formed on the outer periphery of the outer housing 2. The connection portion is configured to be connected to a driving component. In some embodiments, the needle roller screw may be driven by a drive motor. The output end of the drive motor is cooperatively connected to the outer housing 2, to drive the outer housing 2 to rotate about the axis of the outer housing 2, thereby achieving linear motion of the screw central rod 1. In some embodiments, the connection portion is configured as a boss, as shown in FIG. 5. The boss is adapted to mate with structures such as bearings, so as to enable connection between the outer housing 2 and the output end of the drive motor. In some embodiments, the drive motor may be a frameless torque motor.

In the description of the present application, it should be understood that orientation or positional relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, and “circumferential” are based on orientation or positional relationships shown in the drawings, and are merely for the convenience of describing the present application and simplifying the description, rather than indicating or implying that the referred device or element must have a specific orientation, be constructed and operated in a specific orientation, and therefore should not be construed as limiting the present application.

In the description of the present application, a “first feature” and a “second feature” may include one or more of such features.

In the description of the present application, “plurality” means two or more.

In the description of the present application, a first feature being “above” or “below” a second feature may include direct contact between the first and second features, or may include contact between the first and second features not directly but through another feature therebetween.

In the description of the present application, a first feature being “above”, “over”, and “on” a second feature includes the first feature being directly above and obliquely above the second feature, or merely indicates that the first feature is at a horizontal level higher than the second feature.

In the description of the present specification, the descriptions with reference to the terms “one embodiment”, “some embodiments”, “illustrative embodiments”, “examples”, “specific examples”, or “some examples”, etc. mean that specific features, structures, materials, or characteristics described in conjunction with the embodiment or example are included in at least one embodiment or example of the present application. In the present specification, schematic representations of the above terms do not necessarily refer to the same embodiment or example. Furthermore, the described specific features, structures, materials, or characteristics may be combined in any one or more embodiments or examples in a suitable manner.

Although embodiments of the present application have been shown and described, those of ordinary skill in the art can understand that various changes, modifications, substitutions, and variations can be made to these embodiments without departing from the principles and spirit of the present application. The scope of the present application is defined by the claims and their equivalents.

What is claimed is:

1. A needle roller screw, comprising:
a screw central rod, a first helical groove being formed on an outer periphery of the screw central rod;
a screw sleeve sleeved on the outer periphery of the screw central rod, wherein a second helical groove radially opposite to the first helical groove is formed on an inner wall of the screw sleeve, and wherein a third helical groove is formed on an outer wall of the screw sleeve;
an outer housing sleeved on an outer periphery of the screw sleeve, wherein a fourth helical groove radially opposite to the third helical groove is formed on an inner wall of the outer housing; wherein:
the first helical groove and the second helical groove cooperate to form an inner helical raceway, and the third helical groove and the fourth helical groove cooperate to form an outer helical raceway;
return ports are formed on the screw sleeve, two ends of the inner helical raceway being respectively in communication with two ends of the outer helical raceway through the return ports; and
a plurality of needle rollers closely arranged in the outer helical raceway and the inner helical raceway, an axis of each of the plurality of needle rollers being perpendicular to an extending direction of each of the outer helical raceway and the inner helical raceway,
wherein the plurality of needle rollers are configured to circularly roll within the outer helical raceway and the inner helical raceway when the outer housing is rotated relative to the screw central rod.

2. The needle roller screw according to claim 1, further comprising a guide member extending through each of the return ports, a radially inner end of the guide member being cooperatively connected to the screw central rod, a radially outer end of the guide member being cooperatively connected to the outer housing; and the guide member having a return passage through which the inner helical raceway is in communication with the outer helical raceway.

3. The needle roller screw according to claim 2, wherein:
a helical direction of the inner helical raceway is opposite to a helical direction of the outer helical raceway;
each of two ends of the inner helical raceway is connected to one guide member, and
extending directions of two return passages are opposite to each other.

4. The needle roller screw according to claim 2, wherein a limiting groove is formed on the screw central rod, the guide member being at least partially disposed in the limiting groove, to be adapted to be cooperatively connected to the screw central rod.

5. The needle roller screw according to claim 4, wherein the guide member is connected to the limiting groove by an interference fit.

6. The needle roller screw according to claim 2, wherein a protrusion is formed at the radially outer end of the guide member, the protrusion being in sliding engagement with the fourth helical groove to be adapted to be cooperatively connected to the outer housing.

7. The needle roller screw according to claim 1, wherein a plurality of inner helical raceways and a plurality of outer helical raceways are provided, the plurality of inner helical raceways being in one-to-one correspondence with the plurality of outer helical raceways, the plurality of the inner helical raceways being arranged at intervals along an axial direction of the screw central rod, and the plurality of outer helical raceways being arranged at intervals along the axial direction of the screw central rod.

8. The needle roller screw according to claim 1, wherein a part of each of the plurality of needle rollers is constructed into a cylindrical shape, and each of axial end surfaces of the needle roller is constructed as an arcuate shape.

9. The needle roller screw according to claim 1, wherein the screw central rod comprises:
a fitting section, the first helical groove being formed on the fitting section;
a smooth shaft section, one end of the smooth shaft section being connected to the fitting section; and
an output section connected to the other end of the smooth shaft section, wherein:
the output section is configured to be connected to an external structure for outputting linear motion; and
the fitting section is disposed within the outer housing and is configured to drive the smooth shaft section and the output section to move along an axial direction of the outer housing.

10. The needle roller screw according to claim 1, wherein a connection portion is formed on an outer periphery of the outer housing, the connection portion being configured to be connected to a driving component.
